(19) United States
(12) Patent Application Publication
(10) Pub. No.: US 2016/0240964 A1
(43) Pub. Date: Aug. 18, 2016

(54) GROUNDING ASSEMBLY FOR SUNKEN PLACEMENT

(71) Applicant: Michael Clark, Wake Forest, NC (US)

(72) Inventor: Michael Clark, Wake Forest, NC (US)

(21) Appl. No.: 15/046,444

(22) Filed: Feb. 17, 2016

Related U.S. Application Data
(60) Provisional application No. 62/117,904, filed on Feb. 18, 2015.

(51) Int. Cl. H01R 13/60; H01R 13/72; H01R 4/28

(52) U.S. Cl. CPC H01R 13/60; H01R 4/28; H01R 13/72

(57) ABSTRACT

A grounding assembly for sunken placement in a surface includes a housing for sunken placement in a surface. A top plate covers the interior space of the housing. The top plate defines an opening, and a hinging access panel when closed prevents access to the interior space of the housing by covering the opening. At least one grounded cable stored within the interior space of the housing can be deployed through the opening of the top plate. A strut spans the opening of the top plate and supports the access panel when in the closed configuration. An electrical contact such as a clamp is connected to a free end of the grounded cable for grounding an aircraft or other vehicle or equipment.

### CROSS-REFERENCE TO RELATED APPLICATION

This application claims the benefit of priority of U.S. provisional patent application No. 62/117,904, titled “Sunken Grounding Apparatus,” filed on Feb. 18, 2015, which is incorporated herein in its entirety by this reference.

### TECHNICAL FIELD

The present disclosure relates to electrical-grounding equipment. More particularly, the present disclosure relates to an apparatus for storing grounding cable and clamp assemblies in sunken placement.

### BACKGROUND

The electrical grounding of an aircraft while fueled and serviced on land, for example at an airport, is typically accomplished using long cables that in some instances must be extended inconveniently across runway or hangar surfaces. A poorly grounded aircraft represents a significant potential sparking hazard particularly when fueling or defueling. Not only can uncontrolled electrical discharges cause fires, they can cause damage to sensitive electronics equipment as well both to on-board systems and ground-based maintenance and diagnostic equipment.

The grounding cables typically used are appropriately constructed with heavy-gauge wire and so they are cumbersome to extend and move in busy environments where ground vehicles are moving to load, unload and service aircraft recently landed or preparing for flight. It is preferred that such cables not be driven over by vehicles; and the clamps on the ends of the cables are particularly subject to damage or contamination if poorly treated.

Improvements are needed in grounding cable equipment and methods.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, a grounding assembly for sunken placement in a surface includes: a housing for sunken placement in a surface, the housing defining an interior space; a top plate covering the interior space of the housing, the top plate defining an opening; an access panel having a closed configuration, in which the access panel covers the opening of the top plate to prevent access to the interior space of the housing, and at least one open configuration in which the access panel does not cover the opening of the top plate to permit access to the interior space of the housing; and at least one grounded cable at least partially within the interior space of the housing and configured to be deployed through the opening of the top plate.

In at least one example, a strut spans the opening of the top plate and supports the access panel when the access panel is in the closed configuration.

In at least one example, the housing includes a bottom floor and four planar vertical side-wall sections.

In at least one example, a strut has longitudinal ends connected to respective side-wall sections.

In at least one example, the access panel is connected to the top plate by a hinge permitting pivoting of the access panel from the closed configuration to the open configuration.

In at least one example, a reel assembly is included within the interior space of the housing and upon which the grounded cable can be rolled for storage.

In at least one example, a cutout is formed in an edge of the access panel to accommodate the grounded cable when the grounded cable is deployed and the access panel is in the closed configuration.

In at least one example, holes are formed in the top plate to accommodate fasteners by which to fix the grounding assembly to a surface.

In at least one example, the top plate has a traction pattern.

In at least one example, the top plate has holes to receive fasteners for fixing the grounding assembly to a surface.

In at least one example, the housing comprises an outward extending flange contacting the top plate.

In at least one example, the top plate has first holes to receive fasteners for fixing the grounding assembly to a surface; and the flange has second holes respectively aligned with the first holes.

In at least one example, a grounding rod is electrically connected to the at least one grounded cable.

In at least one example, a grounding rod is electrically connected to the at least one grounded cable.

In at least one example, the at least one grounded cable is electrically connected to the housing, and a grounding rod is electrically connected to the housing such that the at least one grounded cable is electrically connected to the grounding rod by way of the housing.

In at least one example, an electrical contact is connected to a free end of the at least one grounded cable.

In at least one example, the electrical contact comprises a clamp.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 is upper perspective view of a grounding assembly for sunken placement in a ground or floor surface according to at least one embodiment.

FIG. 2 is a lower perspective view of the grounding assembly of FIG. 1.

FIG. 3 is a plan view of the top plate of the grounding assembly of FIG. 1 shown with a top-side access panel closed.

FIG. 4 is an example of a traction pattern for the upper surface of the top plate of FIG. 3.

FIG. 5 is a plan view of the top plate of the grounding assembly of FIG. 1 shown with the top-side access panel opened and cables deployed.

FIG. 6 is an elevation view of the grounding assembly of FIG. 1 installed below or flush with a floor or ground surface and showing a view of a reel from which a cable is deployed through the open top-side access panel.

FIG. 7 is a lower perspective view of a grounding assembly, according to at least one embodiment, in which exemplary arrangements for grounding and securing the grounding assembly are illustrated.

FIG. 8 is a plan view of the top side of the lower housing of the grounding assembly, according to at least one embodiment.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

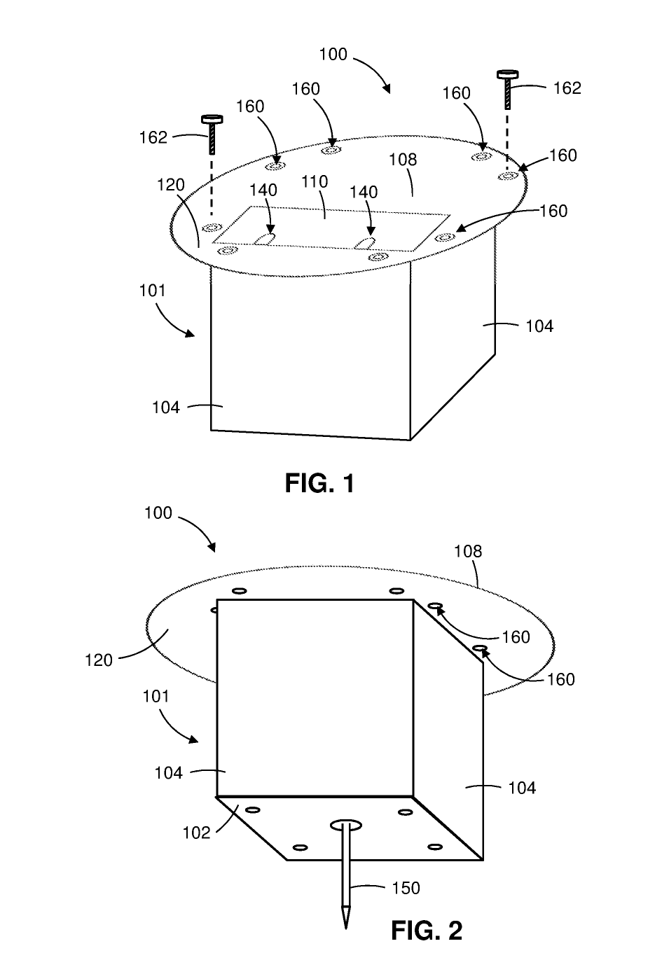

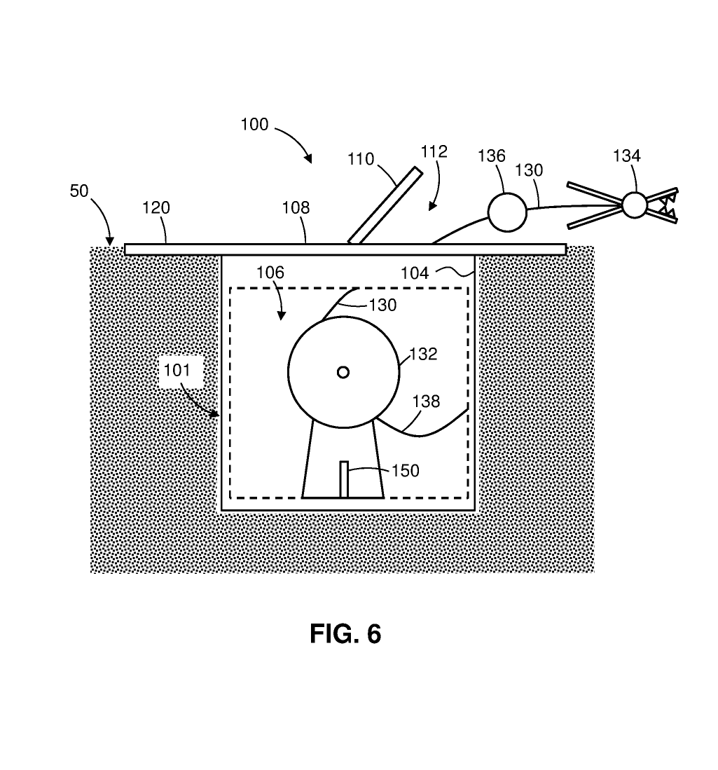

A grounding assembly 100 for sunken placement in a ground or floor surface 50 (FIG. 6) such as that of a hangar, maintenance shop or tarmac is shown in FIGS. 1-6. The grounding assembly 100 has a lower housing 101 shown in a rectangular box-like configuration having a planar bottom floor 102 (FIG. 2) and four planar vertical side-wall sections 104. The side-wall sections 104 together define a continuous wall around an interior enclosure space 106 (FIGS. 5-6). A wall surrounding an interior enclosure space in other embodiments of a grounding assembly according to these descriptions can have more or less side-wall sections. For example, in at least one embodiment such a wall is circularly cylindrical. Other configurations and shapes of the housing 101 are within the scope of these descriptions.

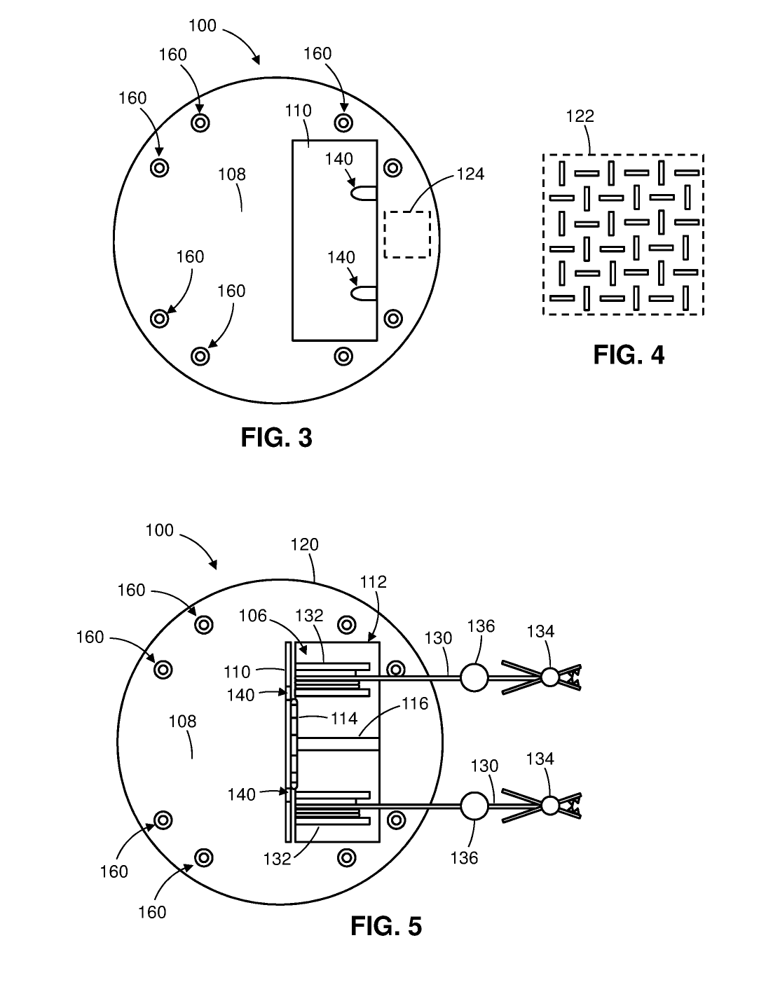

The grounding assembly 100 has a top plate 108 generally covering the interior enclosure space. The top plate 108 is connected to the upper edges of the side-wall sections 104, for example by welding or other attachment. A top-side access panel 110 having open (FIGS. 5-6) and closed (FIGS. 1 and 3) configurations permits access, in an open configuration, to the interior enclosure space 106 of the grounding assembly 100. As shown in FIG. 5, the top-side access panel 110 in an open configuration permits access to the interior enclosure space 106 though an opening 112 defined by the top plate 108. As shown in FIGS. 1 and 3, the top-side access panel 110 in its closed configuration covers or fills the opening 112, preventing access to the interior enclosure space. The access panel 110 is connected in the illustrated embodiment along a marginal edge to the top plate 108 by a hinge 114 (FIG. 5) permitting the access panel 110 to be pivoted around the hinge 114 to open configurations from the closed configuration.

The access panel 110 in at least one embodiment is flush upon closure with the upper surface of the top plate 108 defining floor or ground space where vehicle movements and other operations can occur unobstructed. The top plate 108 and access panel 110 are illustrated as generally planar, expectedly for installation and use with the top plate 108 in a horizontal disposition parallel to and optionally flush with a ground or floor surface 50 (FIG. 6).

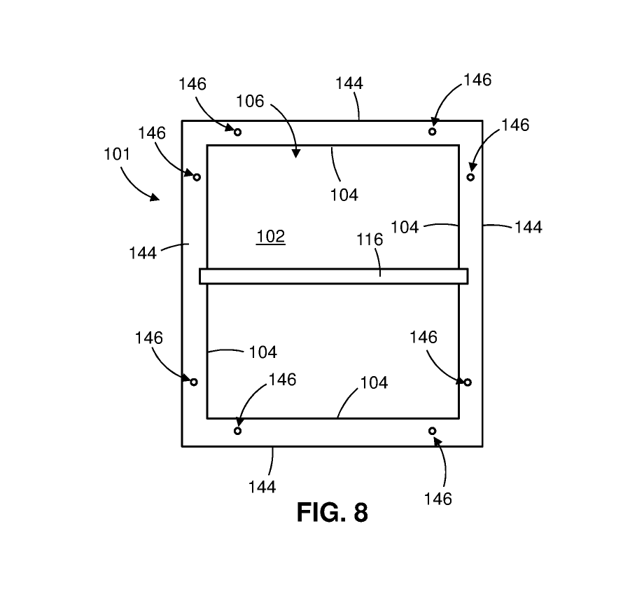

A strut 116 (FIG. 5) spans the opening 112 below the top plate 108, for example to strengthen the grounding assembly 100 and to support the access panel 110 and prevent extension thereof below the closed configuration. For example, in at least one embodiment, the strut 116 is connected at its longitudinal ends to opposite side-wall sections 104 and spans the upper end of the interior enclosure space 106 (FIG. 8). The strut 116 supports the top plate 108 (when closed) and any other load such as a vehicle wheel that may travel over or park on the top plate 108 and access panel 110.

A lip 120 of the top plate 108 extends horizontally defining an upper ground perimeter of the grounding assembly 100, encircling the access panel 110 when hinged down to its closed horizontal position. The top plate 108 can lie upon, flush with, or even slightly below (FIG. 3) the ground surface 50 in various installation preferences. In the sunken placement of the grounding assembly 100 of FIG. 6, the top plate 108 is shown as flush or almost flush with the surrounding ground or floor surface 50.

FIG. 4 is an example of a traction pattern 122 for the upper surface of the top plate 108 and that of the access panel 110 as well. While other examples are within the scope of these descriptions, the traction pattern 122 for example can be formed, stamped, etched, applied, or otherwise effected in any desired area 124 (FIGS. 3,4) of the upper surface of the top plate 108 and across the entire top plate 108 and access panel 110 as desired. The traction pattern 122, and optionally other traction patterns, provides for a repeating non-uniform upper surface of the top plate 108 to increase traction.

Various implements, tools, structures and arrangements are available within the interior enclosure space 106 of the grounding assembly 100 in various embodiments. Advantageous features and implements are particularly illustrated in FIGS. 5 and 6. For example, the expressly illustrated embodiment of the grounding assembly 100 includes grounding cables 130 deployed from reel assemblies 132. When not in use, each grounding cable 130 can be stored upon a respective reel assembly 132, each of which includes a spool upon which a grounding cable 130 is rolled for storage within the interior enclosure space 106 of the grounding assembly 100. The top-side access panel 110 can be closed to protect the stowed cables and assemblies, to prevent tripping, and to prevent tools, debris and vehicle wheels from dropping into the interior enclosure space 106.

FIG. 5 is a plan view of the top plate 108 of the grounding assembly of FIG. 1 shown with the top-side access panel 110 opened and grounding cables 130 deployed to arbitrary lengths representing any desired length of deployment. For deployment and use, the top-side access panel 110 can be opened and each grounding cable 130 can be unrolled from its reel assembly 132 to a desired free length. Each illustrated grounding cable 130 is shown as having an electrical contact 134 at its free end for electrical contact with an aircraft or other structure to be grounded. Thus, the electrical contacts 134 are deployed with the grounding cables 130. As shown in FIG. 3, cutouts 140 are formed in an edge of the access panel 110 to accommodate the grounding cables 130 extending from the grounding assembly 100 even when the access panel is closed.

Each reel assemblies 132 may have spring-return or bias to rewind its cable 130 or may be hand operated for rewinding. In the illustrated embodiment, a respective stop piece 136 is mounted on each grounding cable 130 to halt rewinding as the electrical contact 134 approaches reel assembly 132.

The cables 130 and electrical contacts 134 are electrically conductive, and may have protective insulating sheaths or covers. For example, the grounding cables 130 may have conducting multi-strand metal wire cores sheathed in electrically insulating outer layers of polymer, rubber or other insulating material. The electrical contacts 134 are electrically conductive, and each is in electrical communication with its grounding cable 130. For example, each electrical contact 134 may be a spring-biased clamp having forward electrically conducting jaws. Each electrical contact 134 may have a plug or other terminal arrangement for electrical connection to a corresponding mating plug or other terminal arrangement mounted on or electrically connected to a vehicle such as an aircraft.

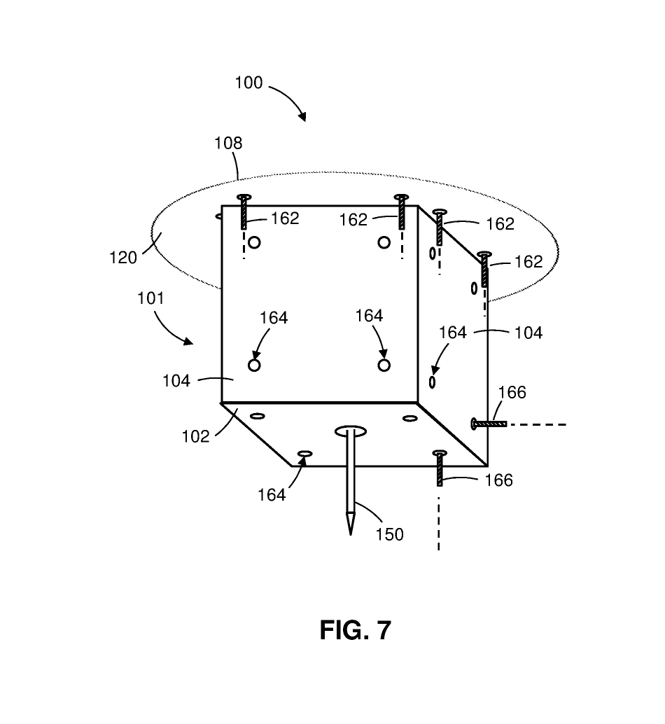

A grounding rod 150 electrically common to the grounding cables 130 is shown in FIGS. 2 and 7 as extending through a central portion of the floor 102 of the grounding assembly 100 to assure electrical grounding to earth. Other placements can be made in various embodiments. The grounding rod 150 assures proper grounding of the grounding cables 130 and electrical contacts 134. The top plate 108, the floor 102 and the side-wall sections 104 may be constructed, for example, of steel, aluminum or other electrically conducting metals. The top plate 108, the floor 102 and the side-wall sections 104 may also be electrically common to the grounding rod 150 as well.

In FIG. 6, the grounding cable 130 is shown as electrically connected to the housing 101, for example by connection 138 to a side-wall section 104. The connection 138 represents an extension of the cable 130, a second cable connected to the cable 130, or any electrical connection between the grounding cable 130 and the housing 101. In that example, the housing 101 is electrically connected to the grounding rod 150. Thus, the grounding cable 130 can be electrically connected to the grounding rod 150 directly or indirectly. In at least one embodiment, the grounding cable 130 is electrically connected to the housing 101, which is grounded to earth by contact without a grounding rod being necessitated. In various embodiments, the housing 101 or at least a part of the housing 101 is electrically conductive.

Holes 160 are shown as formed through the top plate 108 to receive fasteners 162 (FIG. 1) and fix the grounding assembly 100 in an installment area of a ground or floor surface 50 (FIG. 6). The fasteners 162 may be bolts, anchors, or other connectors. A respective annular countersink recess may surround each hole 160 to accommodate a bolt head. Once the grounding assembly 100 is placed as desired, the fasteners 162 are secured into the ground or floor surface 50 to both mechanically secure and electrically ground the assembly 100 and to stabilize the top plate 108. In FIG. 7, additional holes 164 are shown as formed through the floor 102 and side-wall sections 104 to accommodate additional fasteners 166. Additional holes 164 may also be formed to permit drainage in the event liquid such as rain or other work fluids enter the grounding assembly 100.

FIG. 6 is an elevation view of the grounding assembly of FIG. 1 installed below or flush with a floor or ground surface and showing a view of a reel assembly 132 from which a grounding cable 130 is deployed through the open top-side access panel 110. The grounding assembly 100 can be installed in a surface near where aircraft or other vehicles and equipment are to be grounded. For use in electrically grounding a vehicle such as an aircraft while fueled and serviced, each grounding cable 130 can be extended from its respective reel assembly 132. Conveniently, each grounding cable 130 can be returned to its respective reel assembly 132 for safe storage when not in use.

FIG. 8 is a plan view of the top side of the lower housing of the grounding assembly, according to at least one embodiment. In this example, the lower housing 101 has a flange 144 that extends outward parallel to the top plate 108 when assembled. The flange 144 has holes 146 to receive or permit passage of the fasteners 162 (FIG. 1) when fixing the grounding assembly 100 in an installment area of a ground or floor surface 50 (FIG. 6). The holes 146 in the flange 144 are respectively positioned to align with the holes 160 in the top plate 108 (FIG. 1) so as to receive fasteners 162. When so installed, the flange 144 is trapped between ground or floor surface 50 and the lip 120 of the top plate 108.

The top plate 108 is shown as circular in FIGS. 3-4. Other shapes are used in other embodiments. In at least one particularly advantageous embodiments, the top plate is circular and has a diameter of approximately eighteen inches complying with, for example, military specifications for grounding points. For example, the top plate 108 and access panel 110 may be painted or otherwise colored yellow.

As described above, the grounding assembly 100 provides for the grounding of an aircraft and other vehicles and equipment with below surface storage of the grounding cables 130 and electrical contact 134. Installation can be made in locations where grounding is needed. The grounding assembly 100 minimizes the labor in deploying a grounding cable and minimizes the likelihood of vehicles driving over the cables.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims. Features shown in at least one of the drawings may be optionally considered as present in each other drawing whether expressly illustrated or not. These descriptions and the drawings are to be viewed as cumulative.

What is claimed is:

1. A grounding assembly for sunken placement in a surface, the grounding assembly comprising:
a housing for sunken placement in a surface, the housing defining an interior space;
a top plate covering the interior space of the housing, the top plate defining an opening;
an access panel having a closed configuration, in which the access panel covers the opening of the top plate to prevent access to the interior space of the housing, and at least one open configuration, in which the access panel does not cover the opening of the top plate to permit access to the interior space of the housing; and
at least one grounded cable at least partially within the interior space of the housing and configured to be deployed through the opening of the top plate.

2. A grounding assembly according to claim 1, further comprising a strut spanning the opening of the top plate and supporting the access panel when the access panel is in the closed configuration.

3. A grounding assembly according to claim 1, wherein the housing comprises a bottom floor and four planar vertical side-wall sections.

4. For example, in at least one embodiment, further comprising a strut having longitudinal ends connected to respective side-wall sections.

5. A grounding assembly according to claim 1, wherein the access panel is connected to the top plate by a hinge permitting pivoting of the access panel from the closed configuration to the open configuration.

6. A grounding assembly according to claim 1, further comprising a reel assembly within the interior space of the housing and upon which the grounded cable can be rolled for storage.

7. A grounding assembly according to claim 1, wherein a cutout is formed in an edge of the access panel to accommodate the grounded cable when the grounded cable is deployed and the access panel is in the closed configuration.

8. A grounding assembly according to claim 1, wherein holes are formed in the top plate to accommodate fasteners by which to fix the grounding assembly to a surface.

9. A grounding assembly according to claim 1, wherein the top plate has a traction pattern.

11. A grounding assembly according to claim 10, wherein the top plate has holes to receive fasteners for fixing the grounding assembly to a surface.

10. A grounding assembly according to claim 1, wherein the housing comprises an outward extending flange contacting the top plate.

12. A grounding assembly according to claim 10, wherein:
the top plate has first holes to receive fasteners for fixing the grounding assembly to a surface; and
the flange has second holes respectively aligned with the first holes.

13. A grounding assembly according to claim 1, further comprising a grounding rod in electrically connected to the at least one grounded cable.

14. A grounding assembly according to claim 1, wherein the at least one grounded cable is electrically connected to the housing, and further comprising a grounding rod electrically connected to the housing such that the at least one grounded cable is electrically connected to the grounding rod by way of the housing.

15. A grounding assembly according to claim 1, further comprising an electrical contact at a free end of the at least one grounded cable.

16. A grounding assembly according to claim 15, wherein the electrical contact comprises a clamp.
